(19) United States
(12) Patent Application Publication
(10) Pub. No.: US 2014/0269312 A1
(43) Pub. Date: Sep. 18, 2014

(54) BASE STATION HAVING A PLURALITY OF ANTENNAS FOR THE ADAPTIVE OFFLOADING OF AN OVERLOADED AREA

(71) Applicants: Richard Combes, Paris (FR); Sara Akbarzadeh, Paris (FR); Zwi Altman, Chatillon (FR)

(72) Inventors: Richard Combes, Paris (FR); Sara Akbarzadeh, Paris (FR); Zwi Altman, Chatillon (FR)

(73) Assignee: ORANGE, Paris (FR)

(21) Appl. No.: 14/128,463

(22) PCT Filed: Jun. 22, 2012
(86) PCT No.: PCT/FR2012/051440

§ 371 Date: Apr. 3, 2014

(30) Foreign Application Priority Data
Jun. 30, 2011 (FR) 1155906
Jul. 6, 2011 (FR) 1156122

(51) Int. Cl. H04W 28/08

(52) U.S. Cl. CPC H04W 28/08; H04W 52/04
USPC 370/235

(57) ABSTRACT

Telecommunication stations having a wide coverage area are described. Some embodiments relate to a station for transmitting and/or receiving electromagnetic waves, including at least two antenna ports, each antenna port being capable of being connected to a respective group of antennas comprising one or more antennas, the respective signals being fed to the respective antenna ports being identical to one another, except for, if need be, the respective powers thereof, the station further including adjustment components capable of separately adjusting the respective power of at least one of the respective signals, and a control component capable of controlling the adjustment components according to a control signal received by the station. In some embodiments, the telecommunications systems described herein can be used for heterogeneous mobile networks.

The invention relates to the field of telecommunications. More particularly, the invention relates to enlarging the coverage area of stations known as “server stations”, that may be transmit-only stations, receive-only stations, or transceiver stations, operating in the radiofrequency range (e.g. wireless networks) or in some other range of frequencies (e.g. the infrared).

The invention relates in particular to the question of offloading, in which offloading radio stations handle a portion of the communications traffic in such a way as to offload neighboring stations and reduce congestion in heavily-loaded areas, particularly at the times of day in which communications traffic is high.

The invention is compatible in particular with any known radio access technology (time division multiple access (TDMA), code division multiple access (CDMA), wideband CDMA (W-CDMA), orthogonal frequency division multiple access (OFDMA), etc. The invention applies in particular to cellular networks using the global system for mobile communications and general packet radio service (GSM/GPRS) technology as defined in version 97 and later versions of the GSM standard, or using the universal mobile telecommunications system (UMTS) technology, as defined in particular in the standards 23.002, 23.003, and 29.060 of the third-generation partnership project (3GPP), the long-term evolution (LTE) standard, or indeed the high-speed packet access (HSPA) standard.

It should be recalled that whereas GSM uses a data transmission medium that is switched in circuit mode, GPRS adds thereto a new data transmission medium that is switched in packet mode, thus making it possible to provide a mobile station with internet protocol (IP) connectivity that is available continuously, but in which radio resources are allocated only when data needs to be transferred. Subscribers of a mobile operator can thus access services using the IP protocol, such as electronic messaging, file downloading, consulting web pages using the wireless application protocol (WAP).

UMTS uses switching both in circuit mode and in packet mode. UMTS uses the W-CDMA technology as standardized by the 3GPP, and it constitutes a European implementation of the IMT-2000 specifications of the International Telecommunication Union (ITU) for third-generation (3G) cellular radio systems. UMTS enables data contained in IP packets to be exchanged with servers forming part of a network external to the UMTS network, such as the internet.

The LTE standard forms a part of the UMTS standard, however it incorporates numerous modifications and improvements, in particular the use of OFMDA for the downlink and of single-carrier frequency division multiple access (SC-FDMA) for the uplink (instead of W-CDMA as in UMTS). LTE requires radio coverage that is dedicated, and distinct from UMTS coverage.

High-speed packet access (HSPA) is a combination of the high-speed downlink packet access (HSDPA) protocol for the downlink and of the high-speed uplink packet access (HSUPA) protocol for the uplink.

As mentioned above, the invention relates in particular to the means available to an operator for increasing the capacity of the network, in particular in high-traffic areas.

To do this, use is made in cellular mobile networks of cells that are of relatively small or very small size (referred to generally as “small” cells in the context of the present invention), in addition to “macro” cells of conventional size. The term “microcell” is generally used to designate a cell covering an area of radius that is less than 500 meters (m), the term “picocell” is used to designate a cell covering an area of about 200×200 square meters (m²), and the term “femtocell” is used to designate a cell covering an area of about 10×10 m². The coverage area of each station may be limited by controlling its power.

Flexibility in terms of cell size is a characteristic of the second-generation (2G) mobile technology and of subsequent technologies, and it represents a significant factor for increasing the capacity of networks. The power controls implemented in mobile networks make it easier to reduce interference between neighboring cells using the same frequencies. By subdividing cells so as to create a larger number of cells in order to serve high-density areas (this is referred to as “densifying” the network), a cellular network operator can optimize spectrum use and thereby enable capacity to be increased.

Thus, by means of a server station of relatively low power (referred to as a “small” station in the context of the present invention) it is possible to cover a limited area. This makes it possible to increase the capacity of a network in areas where access is difficult or expensive using the conventional “macrocell” approach.

More precisely, a microcell may cover an area such as a shopping center, a hotel, or a transport center. Microcells are often deployed temporarily during sports events or other occasions where it is known in advance that additional capacity will be needed at a specific location.

A picocell generally covers an area of small size, e.g. inside a building (offices, shopping centers), or more recently inside an airplane. Picocells are generally used to extend coverage to indoor areas, i.e. areas where outdoor signals do not penetrate well, or in order to increase network capacity in areas of high-density telephone use, as in train stations. A picocell base station is generally a low-cost unit of small size and relatively simple. Picocells are available for most cellular technologies, such as GSM/GPRS, UMTS, and LTE.

In GSM/GPRS networks in particular, each picocell base station is connected to a base station controller (BSC). Numerous picocells are connected to each BSC; the BSC manages radio resources and handover functions (i.e. enabling a mobile terminal to migrate from a cell to a neighboring cell), and it aggregates data for the purposes of transmission to the mobile switching center (MSC) and/or to the gateway GPRS support node (GGSN). Connectivity between picocell units and the BSC is generally provided by means of cabling within a building; more recent systems make use of Ethernet cabling; airplanes use satellite connections.

Recent developments relate to a unit that contains not only a picocell station, but that is also suitable for performing many of the functions of a BSC and some of the functions of an MSC. A picocell of this type is sometimes referred to as an “access point base station” or a “business femtocell”. Under such circumstances, the unit contains all of the means required for connecting directly to the internet, without any need for the BSC/MSC infrastructure. This is potentially a more cost-effective approach.

UMTS networks may include private networks (e.g. home networks) constituted by cells of small size referred to as “femto NodeBs”, in which the base stations, referred to as “Home NodeBs” (HNBs) combine the functions of a NodeB and of a radio network controller (RNC). Each HNB is connected to an HNB gateway situated outside the private network in the radio access network of the operator; the HNB gateway manages the HNB and subscriber traffic, and it acts as an intermediary with the core network. It should be observed that GSM networks also include HNB gateways having analogous functions.

In addition to the above-described technologies, the invention applies in particular to so-called “femto 3G” architectures as defined in the 3GPP document TR 25.820 V8.2.0 (2008-09), and also to future “femto LTE” architectures. These architectures use femtocells in which it is possible to deploy a low-cost home mobile network by using the broadband infrastructure already available to the subscriber. This context is of ever increasing advantage for operators: it is expected that a significant proportion of subscribers to future telephone plans will possess a femtocell. In addition, such femtocells will have the option of making their access available to other users (open access or hybrid access).

Thus, one known solution for increasing the capacity of a network consists in installing additional stations in high-traffic areas. Nevertheless, it is clear that the drawbacks of increasing the numbers of additional stations are the costs of purchasing, installing, and maintaining such new stations.

A priori, another solution would consist in increasing the coverage areas of stations by increasing their pilot powers. On arriving in a network, mobile terminals generally attach themselves to the server station from which the received pilot signal is the strongest, and they therefore attach themselves to a small local cell rather than to the macro-network, providing the pilot power received from the local station is greater than that received from the macro station. Proposals have thus been made to deploy so-called “heterogeneous” networks that comprise both macrocells and small cells (e.g. femtocells) managed by the same operator. Such heterogeneous networks would enable a small station to offload a neighboring macro station by absorbing a portion of the traffic of that macro station, in particular if access to the small station is open to any of the subscribers of said operator.

In this respect, it is useful to consider the results of a study concerning LTE networks, and published in the article “Enhanced LTE network capacity using self-organized femtocell offloading”, by Sara Akbarzadeh, Richard Combes, and Zwi Altman (presented at Globecom 2011). Accompanying FIG. 1a, based on that article, shows the mean blocking rate in a macro/femto network as a function of the power transmitted by the femto stations; accompanying FIG. 1b, also based on that article, shows the network capacity as a function of the power transmitted by the femto stations. In these figures, the marked curves relate to a purely macro-network (i.e. without femtocells), and the plain curves relate to a macro/femto heterogeneous network. These curves show that in order for the introduction of femtocells in a macro network to be able to provide significant improvement, it is necessary for the femtocells to transmit with power higher than 25 decibels relative to 1 milliwatt (dBm), e.g. 40 dBm. Unfortunately, such values are well beyond the acceptable power values for femto stations, in particular because of the limits on transmission powers set by the standards in force concerning the exposure of people to electromagnetic waves.

Patent application WO 96/37010 discloses a cellular telecommunications system comprising a base station connected to a plurality of antennas all transmitting the same signal. When that base station is used as a micro station to serve the inside of a building, the respective antennas are placed in respective rooms of the building; the micro station serves “cold spots” (areas of the building in which the signal from the surrounding macrocell is too weak), and “hot spots” (areas of the building in which the signal from the surrounding macrocell is strong enough); the micro station is suitable for offloading the macrocell in the hot spots.

It should be observed that the system proposed in patent application WO 96/37010 is advantageously different from a system comprising a base station in each area of the building that is to be served, with this applying mainly for two reasons. The first reason is that the various stations operate via the base station to share the same direct backhaul link to the mobile core network or the fixed network. The second reason is that the respective signals transmitted by the various antennas are identical; in other words there is no reuse of resources among the various antennas (i.e., depending on the underlying radio technology: time, frequencies, time/frequency, codes, etc.).

The present invention thus provides a station for transmitting and/or receiving electromagnetic waves, the station having at least two antenna ports, each respective antenna port being suitable for being connected to a respective group of antennas comprising one or more antennas, the respective signals fed to the respective antenna ports being identical with each other except for the possibility of having respective powers that are different, said station further comprising:

adjuster means suitable for separately adjusting the respective power of at least one of said respective signals; and

control means suitable for controlling said adjuster means in compliance with a control signal received by said station.

The authors of the present invention have understood that, in practice, the needs of a network operator in terms of offloading are not constant: on the contrary, they may vary considerably as a function of the time of day, the day of the year, maintenance work, new equipment being installed, or old equipment being removed, and so on. As recalled above, mobile terminals attach themselves to the server station from which they receive the strongest pilot signal, and consequently the possibility of diverting a smaller or larger portion of the communications traffic managed by a macro station to a small station depends on the relative powers between the pilot signal transmitted by the macro station and the pilot signal transmitted by the small station in the geographical area surrounding the small station. The authors of the present invention have concluded that it would be most advantageous, depending on the needs of the moment, to be able to adjust the power that is transmitted by a small station in a hot spot, without that affecting accordingly the power transmitted by the small station in a cold spot, since the traffic needs in the cold spot (and the constraints concerning exposing people to electromagnetic radiation) are usually stable over time.

That is why the present invention provides for the power of the signal fed to at least one antenna port of the server station to be capable of being adjusted separately from the power of the signals fed to the other antenna ports, with this being performed remotely by the network operator, for example, or else by the possessor of a small station acting directly on the appliance. For example, provision may be made for it to be possible to adjust separately the power of all of the signals being fed to one antenna port of the server station, or the power of all of the signals with the exception of one of them (e.g. the port feeding an antenna situated in a cold spot).

It should be observed that this characteristic of the station of the invention does not appear in the telecommunications system of patent application WO 96/37010, in which, by construction, the various transmitters transmit signals, in particular control channel (CCH) pilot signals, that all have the same power.

It is naturally possible for the adjustment means of the present invention to be controlled in various ways.

For example, the station of the invention may be provided means for receiving said control signal from a network operator via the backhaul link with the core network, and/or with means for receiving said control signal from the network operator or from a network technician via a wireless link.

The invention also provides a telecommunications system. Said system is remarkable in that it comprises a station for transmitting and/or receiving electromagnetic waves as described briefly above connected to at least two groups of antennas, and in that each respective group of antennas is situated in a respective geographical area, each separated from other analogous geographical areas by at least one wall.

This telecommunications system may naturally form part of a heterogeneous mobile network, or of a wireless network such as a WiFi network, for example.

It should be observed that the term “antenna” is used herein (in conventional manner) to designate any article capable of radiating or picking up electromagnetic waves and connected to a station core via a transmission line or a waveguide. For example, a WiFi relay or a GSM relay does not constitute an antenna in the meaning of the invention.

It should also be observed that the term “wall” is used herein (in conventional manner) to designate a surface that absorbs or reflects electromagnetic waves at the frequencies in use, and does so in full or in part.

The telecommunications system of the invention makes it possible for a macrocell surrounding the system to be offloaded in a manner that is optimized over time, i.e. while taking account of the needs of the network operator so as to make it possible at any moment and with the available hardware resources to satisfy the communications traffic of that operator's subscribers. According to particular characteristics, a first geographical area is situated inside a building, and a second geographical area is situated outside that building.

The authors of the present invention have realized that the difficulties in extending the coverage of a given station serving the building beyond that building are due mainly to elements in the surroundings, such as walls and metal articles, which strongly attenuate the signal by giving rise to multiple reflections, diffractions, and losses.

Because of these provisions, a server station having coverage that in the prior art was limited to the inside of a building, is capable by virtue of the invention, of increasing its coverage to a certain distance around the building. As a result, users who are outside the building (but not too far away) can connect to this station.

It should be observed in passing that this telecommunications system is very different from known multi-antenna systems. For example, application WO 2009/029011 discloses a system comprising a base station connected to a plurality of antennas arranged inside and outside a building, but in which the respective antennas transmit (as a function of the respective terminals with which they are individual in communication) respective signals that differ in terms of the resources used.

The telecommunications system of the invention provides a significant increase of capacity in dense deployment areas, e.g. in urban areas; indeed, it suffices to deploy systems of the invention in order to massively increase the capacities of mobile networks in an urban area, since such systems are capable of offloading the surrounding macrocells much better than prior art small stations (macro, micro, pico, or femto), and this is possible at a cost that is very low compared with installing a new small station.

An additional advantage of the invention is a drop in the power consumption of mobile terminals and a drop in the radiation emitted by such mobile terminals since, given that the access on offer to the network becomes more dense, a mobile terminal is capable of communicating via a station that is closer to that terminal, and so the mobile terminal transmits at reduced power. This makes it possible in particular to spare the battery (and thus to increase the battery life of the mobile terminal), and to reduce the exposure of the users of terminals to electromagnetic radiation.

The invention also provides a computer program downloadable from a communications network and/or stored on a computer-readable medium and/or executable by a microprocessor. The computer program is remarkable in that it includes instructions for managing the operation of a station as described briefly above, on being executed on a computer.

The advantages made available by the computer program are essentially the same as those made available by said station.

Other aspects and advantages of the invention appear on reading the following detailed description of particular embodiments given as non-limiting examples. The description refers to the accompanying drawings, in which:

FIG. 1a, described above, shows the mean blocking rate in a macro/femto network as a function of the power transmitted by the femto stations;

FIG. 1b, described above, shows the capacity of a macro/femto network as a function of the power transmitted by the femto stations;

FIGS. 2a and 2b are block diagrams showing the structure of a server station in two embodiments of the invention;

FIG. 3 is a diagram of a conventional architecture for a UMTS network having “femto NodeB” cells; and

FIG. 4 shows an embodiment of the telecommunications system of the invention.

FIGS. 2a and 2b are diagrams showing the structure of a server station in two embodiments of the invention. By way of example, consideration is given to the application of the invention to a cellular mobile radio network.

In conventional manner, the server station 1 is connected by a backhaul link 2 to the mobile core network 3, and it includes a transceiver 4.

In accordance with the invention, said transceiver 4 is connected to at least two antenna ports. On transmission, the antenna ports deliver to the antennas, or the groups of antennas, signals that are identical (in particular the pilot signal), except that the powers of the signals might possibly be different. An adjuster unit 5 is specifically suitable for adjusting the power of each of the respective amplifiers connected to respective antenna ports.

The adjuster unit 5 is controlled by a control unit 6 that can itself be controlled by an external control signal. Optionally, the control unit 6 is also controllable by manual action on the station 1 by the user of the station 1 or by a technician working for the network operator; by way of example, said manual action may serve to establish a reference power level for each of said amplifiers so as to compensate for the line losses between each amplifier and the corresponding antenna.

The content of this external control signal is determined by a configuration server 7 associated with the core network 3 as a function of the needs of the operator concerning the powers transmitted by the various antennas of the station 1.

FIG. 2a shows a first variant in which the control signal is conveyed by the backhaul link 2. FIG. 2b shows a second variant in which the control signal is conveyed via a wireless link (e.g. a radio link or an optical link) 8 between the configuration server 7 and the control unit 6.

Consideration is given below to a telecommunications network having a total number A, where A≧2, of antennas or of antenna groups fitted to the stations of the network. In this respect, it should be recalled that it is conventional to use antenna groups in multiple-input single-output (MISO) systems and in multiple-input multiple-output (MIMO) systems. Below, the term “antenna” is used to designate either an antenna proper, or a group of antennas.

For each antenna of number s, where s=1, . . . , A, let h_{s→\vec{r}} be the attenuation of the signal between that antenna and a point \vec{r} of the network. It should be recalled that attenuation, also known as “path loss”, characterizes the loss to which an electromagnetic wave is subjected on traveling a certain distance (cf. http://en.wikipedia.org/wiki/Path-loss); this loss is due to power being dispersed, and also to obstacles the wave encounters on its path.

Let Dₛ be the geographical area served by antenna number s, in other words:

Dₛ={\vec{r}|h_{s→\vec{r}}>h_{s′→\vec{r}}∀s′∈1, . . . , A and s′≠s}

The telecommunications system of the invention comprises a server station as described briefly above that is connected to at least two antennas (or antenna groups). Each antenna is situated in a respective geographical area that is separated from each of the other analogous geographical areas by at least one wall. Advantageously, the use of a plurality of antennas enables the server station of the invention to serve a plurality of geographical areas simultaneously as a function of the communications traffic in each of those areas.

As an example embodiment of the invention, consideration is given below to its application to a UMTS network.

FIG. 3 is a diagram showing a conventional architecture for a UMTS network that includes “femto NodeB” cells as mentioned above.

The UMTS network is subdivided into two subnetworks, the UMTS terrestrial radio access network (UTRAN) and the core network (CN). The UTRAN has a plurality of base radio stations each referred to as a NodeB, for communicating with subscriber devices or “user equipment” (UE) by means of radio resources allocated by a radio network controller (RNC). In UMTS networks, the RNC performs a role equivalent to that performed by BSCs in GSM networks: the RNC controls the NodeBs by allocating the available UTRAN and CN resources thereto, and by supplying them with information for broadcasting within their cells. An RNC serves as an intermediary between the NodeBs and the CN; it communicates with the CN for exchanging data and signaling.

In both the GSM and the UMTS architectures, the core network CN hosts a home location register (HLR) storing information relating to each subscriber of the operator of the network, such as the subscriber's call number, the identity of mobile station, and information about the subscription. The HLR also contains quality of service information associated with subscribers and services. It is thus from this database that the mobile subscribers are managed within the network.

In both the GSM and the UMTS architectures, the core network CN also hosts mobile switching center (MSC) circuits and serving GPRS support node (SGSN) packet switches. These service nodes of the core network serve to manage the communications link with the access network. They store the profile of the subscriber as obtained from the HLR once the subscriber's equipment UE has registered with the network, and they control the radio resources requested by the subscriber.

For circuit mode switching, an MSC is associated with another service node known as the gateway mobile switching center (GMSC) (not shown in FIG. 2), which acts as a gateway to fixed networks such as the public switched telephone network (PSTN) or the integrated services digital network (ISDN).

For packet mode switching, the SGSN manages roaming, authentication, and encryption. It is associated with the gateway GPRS support node (GGSN) (not shown in FIG. 2), which serves as a gateway to external packet switching networks, and in particular the internet. The UMTS core network for packet switching is thus connected to the outside via the GGSN, which contains the routing information enabling the mobile station to communicate with an external network. The SGSN and the GGSN incorporate IP router functions.

FIG. 4 is a diagram of an embodiment of the telecommunications system of the invention.

This figure shows a server station 1 acting as a Home NodeB (HNB) and connected to two antennas, one of which is indoors (inside the house) and the other outdoors. The indoor antenna serves a geographical area D₁ inside the house, and the outdoor antenna serves a geographical area D₂ outside the house.

The control signal of the invention makes it possible, advantageously, to vary the degree of offloading of the macro station that is performed by the HNB 1, with this being done by acting on the respective powers of the signals transmitted by the two antennas.

Compared with a conventional HNB (connected to an indoor antenna only), adding an outdoor antenna makes it possible to enlarge the coverage of the HNB, while maintaining conventional radiated power levels.

Finally, it should be recalled that applications of the present invention are not limited to cellular mobile networks. The invention may be applied for example to wireless networks (using radiofrequencies or other frequencies), such as WiFi networks.

As mentioned above, the present invention also provides a computer system managing the operation of a station as described above. In conventional manner, the computer system includes a central processor unit using signals to control a memory, and also an input unit and an output unit.

In addition, the computer system may be used to execute a computer program including instructions for managing the operation of a station of the invention.

The invention also provides a computer program that is downloadable from a communications network and that includes instructions for managing the operation of a station of the invention when executed by a computer. The computer program may be stored on a computer-readable medium and it may be executable by a microprocessor.

The program may use any programming language, and may be presented in the form of source code, object code, or code intermediate between source code and object code, in a partially compiled form, or in any other desirable form.

The invention also provides a computer-readable data medium that is non-removable or partially or completely removable, and that includes instructions of a computer program as mentioned above.

The data medium may be any entity or device capable of storing the program. For example, the medium may comprise storage means such as a read-only memory (ROM), e.g. a compact disk (CD) ROM, or a microelectronic circuit ROM, or it may include magnetic recording means, e.g. a universal serial bus (USB) flash drive or a hard disk.

Furthermore, the computer medium may be a transmissible medium such as an electrical or optical signal suitable for being conveyed via an electrical or optical cable, by radio, or by other means. The computer program of the invention may in particular be downloaded from an internet type network.

In a variant, the computer medium may be an integrated circuit in which the computer program is incorporated, the circuit being adapted to execute or to be used for the purpose of managing the operation of a station of the invention.

1. A station for transmitting and/or receiving electromagnetic waves, the station having at least two antenna ports, each respective antenna port being suitable for:
being connected to a respective group of antennas comprising one or more antennas, and
being fed by a respective signal, said respective signals being pairwise either identical, or different only in terms of their respective powers,
said station comprising an adjuster suitable for separately adjusting the respective power of at least one of said respective signals, wherein said station further comprises a control suitable for controlling said adjuster in compliance with a control signal received by said station.

2. A station according to claim 1, said station comprising a component configured to receive said control signal from a network operator via a backhaul link to the core network.

3. A station according to claim 1, said station comprising a component configured to receive said control signal from a network operator via a wireless link.

4. A telecommunications system, comprising a station according to claim 1 connected to at least two groups of antennas, wherein each respective group of antennas is situated in a respective geographical area each separated from other analogous geographical areas by at least one wall.

5. A telecommunications system according to claim 4, wherein a first geographical area is situated inside a building, and a second geographical area is situated outside that building.

6. A telecommunications system according to claim 4, wherein said telecommunications system forms part of a heterogeneous mobile network.

7. A telecommunications system according to claim 4, wherein said telecommunications system forms part of a wireless network.

8. A non-transient data storage medium that is non-removable, or partially or completely removable, comprising computer program code instructions for managing the operation of a station according to claim 1.

9. A computer program downloadable from a communications network and/or stored on a non-transient computer-readable medium and/or executable by a microprocessor, said program comprising instructions for managing the operation of a station according to claim 1, when it is executed by a computer.
